(19) United States
(12) Patent Application Publication
(10) Pub. No.: US 2026/0121235 A1
(43) Pub. Date: Apr. 30, 2026

(54) CONDUCTIVE MODULE

(71) Applicant: YAZAKI CORPORATION, Tokyo (JP)

(72) Inventors: Katsunori Sato, Makinohara-shi (JP); Tatsuya Oga, Makinohara-shi (JP); Mariko Nakagawa, Makinohara-shi (JP); Masato Tanaka, Makinohara-shi (JP)

(21) Appl. No.: 19/004,158

(22) Filed: Dec. 27, 2024

(30) Foreign Application Priority Data
Jan. 16, 2024 (JP) 2024-004786

(51) Int. Cl. H01M 50/503; H01M 50/507

(52) U.S. Cl. CPC H01M 50/503; H01M 50/507

(57) ABSTRACT

A conductive module includes: a bus bar connected to electrode terminals of a pair of battery cells in a battery module; a circuit conductor component; a first case in which a bus bar accommodating portion that accommodates the bus bar at an accommodation completion position inside is provided for each bus bar; and a second case provided with a circuit accommodating portion, in which the bus bar accommodating portion has a bottom wall, the first case has a first engaging portion, and the second case has a bus bar holding portion provided for each bus bar accommodating portion to sandwich the bus bar at the accommodation completion position with the bottom wall, and a second engaging portion provided for each bus bar accommodating portion and engaged with the first engaging portion to maintain the bus bar holding portion at a position for sandwiching the bus bar.

### CROSS-REFERENCE TO RELATED APPLICATION(S)

The present application claims priority to and incorporates by reference the entire contents of Japanese Patent Application No. 2024-004786 filed in Japan on Jan. 16, 2024.

### BACKGROUND OF THE INVENTION

### 1. Field of the Invention

The present invention relates to a conductive module.

### 2. Description of the Related Art

The conductive module is a wiring module that electrically connects a battery module in which a plurality of battery cells are arranged and a battery monitoring unit that monitors a battery status of the battery cells. The conductive module includes a bus bar physically and electrically connected to an electrode terminal of one battery cell or electrode terminals of one pair of battery cells of the battery module, a circuit conductor for each bus bar that electrically connects the bus bar to the battery monitoring unit, an electrical connection component that physically and electrically connects the bus bar to the circuit conductor, and a case that accommodates them. This type of conductive module is disclosed in, for example, Japanese Patent Application Laid-open No. 2020-119653.

Meanwhile, the case has a bus bar accommodating member in which a bus bar accommodating portion is formed for each bus bar, and the bus bar is stopped in a bus bar accommodating chamber of the bus bar accommodating portion by a bus bar holding portion provided in the chamber. For example, the conventional bus bar holding portion includes a cantilevered flexible portion extending toward a bottom wall in a depth direction of the bus bar accommodating chamber, and a claw portion provided at a free end of the flexible portion on the bottom wall side. The bus bar holding portion holds the bus bar inside the bus bar accommodating chamber between the claw portion and the bottom wall by entering the bus bar between the claw portion and the bottom wall while bending the flexible portion. In the conventional bus bar accommodating member, in order to ensure the holding function of the bus bar holding portion, it is necessary to make the depth of the bus bar accommodating chamber large relative to the physique in a thickness direction of the bus bar. Therefore, in the conventional conductive module, there is a limit in reducing the size of the bus bar accommodating member in the depth direction of the bus bar accommodating chamber, and there is room for improvement in reducing the height.

### SUMMARY OF THE INVENTION

Therefore, an object of the present invention is to provide a conductive module of which the height can be reduced.

In order to achieve the above mentioned object, a conductive module according to one aspect of the present invention includes a bus bar physically and electrically connected to electrode terminals of a pair of battery cells in a battery module in which a plurality of battery cells are arranged; a circuit conductor component provided with a circuit conductor that electrically connects the bus bar to a battery monitoring unit; a first case in which a bus bar accommodating portion that accommodates the bus bar at an accommodation completion position inside is provided for each bus bar; and a second case provided with a circuit accommodating portion that accommodates the circuit conductor component inside, wherein the bus bar accommodating portion is provided with a space for connecting the bus bar and the electrode terminals, and has a bottom wall on which the bus bar is placed at the accommodation completion position, the first case has a first engaging portion provided for each bus bar accommodating portion, and the second case has a bus bar holding portion provided for each bus bar accommodating portion to sandwich the bus bar at the accommodation completion position with the bottom wall, and a second engaging portion provided for each bus bar accommodating portion and engaged with the first engaging portion to maintain the bus bar holding portion at a position for sandwiching the bus bar.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is an exploded perspective view illustrating the conductive module according to the embodiment;

FIG. 3 is an exploded perspective view illustrating the conductive module, in a state before a cover member is assembled, according to the embodiment;

FIG. 4 is an exploded perspective view for explaining a bus bar holding structure; and

FIG. 5 is a perspective view illustrating a battery module.

### DETAILED DESCRIPTION OF THE PREFERRED EMBODIMENTS

Hereinafter, an embodiment of a conductive module according to the present invention will be described in detail with reference to the drawings. Note that the present invention is not limited by the embodiment.

### Embodiment

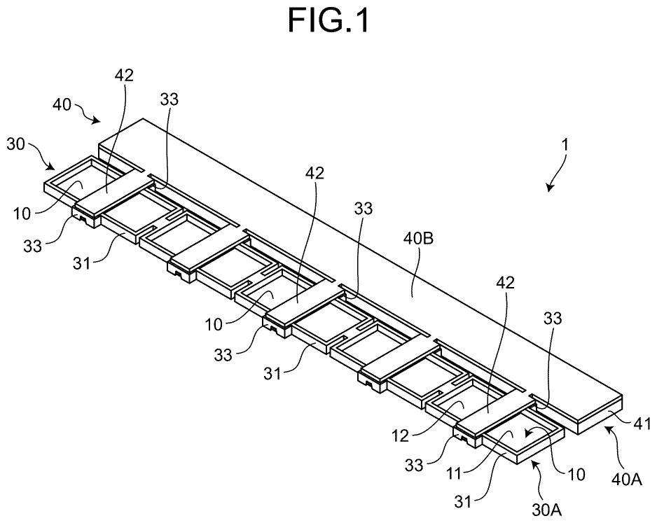

One embodiment of a conductive module according to the present invention will be described with reference to FIGS. 1 to 5.

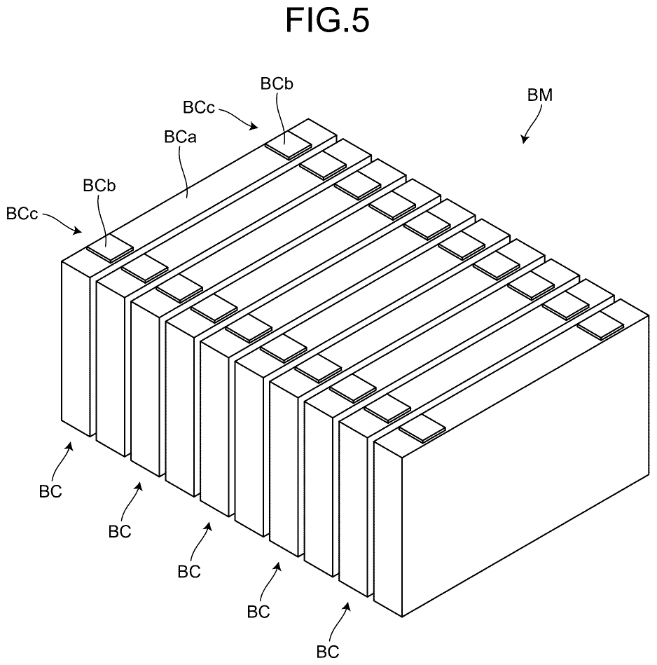

Reference numeral 1 in FIGS. 1 to 4 denotes a conductive module of the present embodiment. The conductive module 1 is assembled to a battery module BM (FIG. 5) in which a plurality of battery cells BC are arranged (for example, arranged in one row) to electrically connect the battery module BM to a battery monitoring unit (not illustrated) such that the battery monitoring unit monitors the battery status of the battery cells BC. The conductive module 1 constitutes a battery pack together with the battery module BM. The battery pack is mounted on, for example, a vehicle (a battery electric vehicle (BEV), a hybrid electric vehicle (HEV), or the like) including a rotary machine as a drive source, and is used to supply power to the rotary machine.

The battery cell BC includes a cell body BCa and positive and negative electrode terminals BCb (FIG. 5). In the battery cell BC illustrated here, the cell body BCa is formed like a rectangular parallelepiped having six outer wall surfaces. In the plurality of battery cells BC constituting the battery module BM, the cell bodies BCa adjacent to each other in an arrangement direction are arranged such that the respective one outer wall surfaces face each other. The battery module BM includes one electrode terminal group BCc in which the electrode terminals BCb of the battery cells BC on one side are arranged along the arrangement direction, and the other electrode terminal group BCc in which the electrode terminals BCb of the battery cells BC on the other side are arranged along the arrangement direction.

In this example, each battery cell BC includes positive and negative electrode terminals BCb on one of the six outer wall surfaces of the cell body BCa (FIG. 5). Therefore, in the battery module BM, two electrode terminal groups BCc are provided on one plane (hereinafter referred to as an “electrode installation surface”) (FIG. 5).

However, there is also known a battery cell BC in which a positive electrode terminal BCb is provided on one of the six outer wall surfaces of the cell body BCa, and a negative electrode terminal BCb is provided on another one of the six outer wall surfaces of the cell body BCa, although not illustrated. In the battery module BM including such battery cells BC, the electrode terminal groups BCc are provided on different planes. The plane is a portion referred to as the side wall surface of the battery module BM exemplified above. The conductive module 1 of the present embodiment is also applied to such a battery module BM.

The electrode terminal BCb illustrated here is formed like a flat plate, and physically and electrically connects a bus bar 10 to be described below by welding or the like. However, the electrode terminal BCb may be formed like a pole having a male screw portion.

The conductive module 1 includes a bus bar 10 physically and electrically connected to electrode terminals BCb of a pair of battery cells BC in the battery module BM (FIGS. 1 to 4).

The bus bar 10 is a plate-like conductive component made of a metal, and is formed by press-molding, for example, a metal plate as a base material. The bus bar 10 includes a first electrical connection portion 11 physically and electrically connected to one of the electrode terminals BCb, a second electrical connection portion 12 physically and electrically connected to the other one of the electrode terminals BCb, and a connecting portion 13 having a bent shape and connecting the first and second electrical connection portions 11 and 12 to each other (FIGS. 1 to 4).

The first electrical connection portion 11 and the second electrical connection portion 12 are formed like a rectangular flat plate on the same plane, and are arranged with a gap between their sides in the arrangement direction of the pair of adjacent electrode terminals BCb (that is, the arrangement direction of the plurality of battery cells BC). The connecting portion 13 has a cross section formed in a U-shape such as a C-shape in a direction orthogonal to the arrangement direction of the first electrical connection portion 11 and the second electrical connection portion 12 and the direction vector of the perpendicular to the plane of the first electrical connection portion 11 (the second electrical connection portion 12), and connects the sides in such a manner as to fill the gap between the first electrical connection portion 11 and the second electrical connection portion 12. In the connecting portion 13, a groove portion extending in the orthogonal direction is formed inside the U-shape.

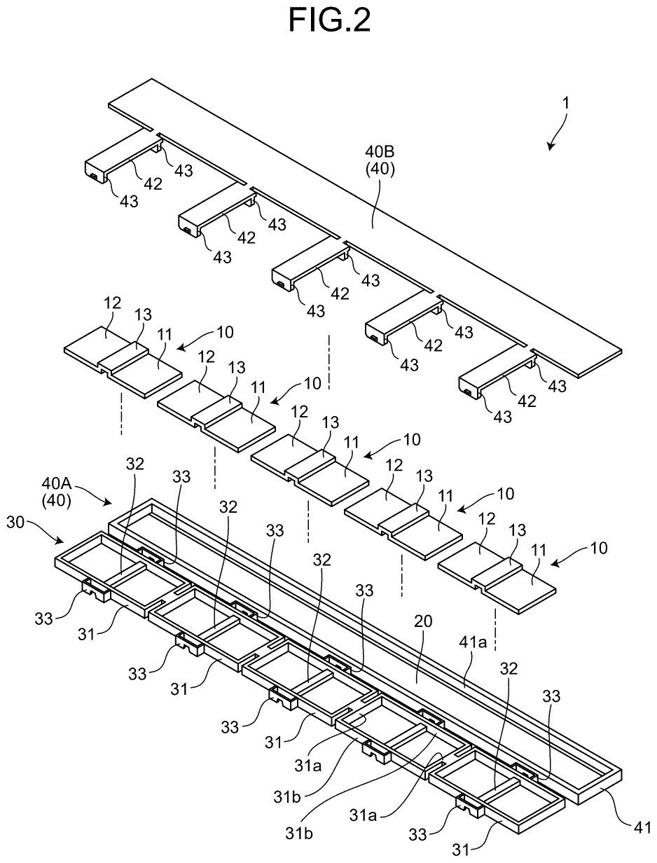

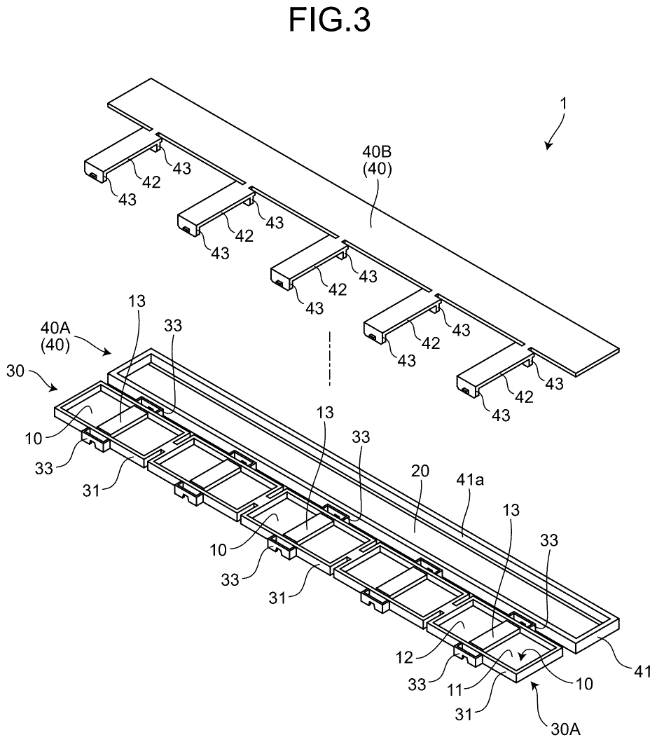

Further, the conductive module 1 includes a circuit conductor component 20 provided with a circuit conductor (not illustrated) that electrically connects the bus bar 10 to the battery monitoring unit (FIGS. 2 and 3). The conductive module 1 includes an electrical connection component (not illustrated, e.g., a conductive component such as a terminal fitting or an electric wire) for each bus bar 10, the electrical connection component being physically and electrically connected to the bus bar 10 and the circuit conductor forming a pair to electrically connect the bus bar 10 and the circuit conductor.

As the circuit conductor component 20, for example, a flexible printed circuit (FPC) board on which a conductor pattern as a circuit conductor is formed for each bus bar 10, a rigid board on which a conductor pattern as a circuit conductor is formed for each bus bar 10, an electric wire including a core wire as a circuit conductor for each bus bar 10, or the like is used. Here, a flexible printed circuit board is used as the circuit conductor component 20.

The conductive module 1 includes a first case 30 in which a bus bar accommodating portion 31 for accommodating the bus bar 10 at an accommodation completion position inside is provided for each bus bar 10, and a second case 40 in which a circuit accommodating portion 41 for accommodating the circuit conductor component 20 inside is provided (FIGS. 1 to 4). The first case 30 and the second case 40 are formed of an insulating material such as a synthetic resin.

The first case 30 includes a bus bar accommodating member 30A in which the bus bar accommodating portion 31 is formed for each bus bar 10 (FIGS. 1 to 4). In the first case 30, the bus bar accommodating portions 31 for the respective bus bars 10 are arranged along the arrangement direction of the plurality of battery cells BC. The first case 30 may include a cover member that covers the inside of each bus bar accommodating portion 31 together with the bus bar 10 placed at the accommodation completion position.

The bus bar accommodating portion 31 is formed like a square ring having a pair of first side walls 31a arranged to face each other with a space therebetween in the arrangement direction of the plurality of battery cells BC, and a pair of second side walls 31b arranged to face each other with a space therebetween in the extending direction of the connecting portion 13 in the bus bar 10 at the accommodation completion position (FIG. 2).

The bus bar accommodating portion 31 is provided with a space for connecting the bus bar 10 and the electrode terminals BCb, and has a bottom wall 32 on which the bus bar 10 is placed at the accommodation completion position (FIG. 2). The bottom wall 32 is a connecting wall that connects the pair of second side walls 31b, and enters the U-shaped inner groove portion of the connecting portion 13 when the bus bar 10 is at the accommodation completion position. When the bus bar 10 is at the accommodation completion position, the groove bottom of the connecting portion 13 is placed on the bottom wall 32.

In the bus bar accommodating portion 31, the bus bar 10 is inserted toward the bottom wall 32 in the axial direction of the square ring shape.

The second case 40 includes a circuit accommodating member 40A in which the circuit accommodating portion 41 is formed, and a cover member 40B that covers a port 41a for inserting the circuit conductor component 20 in the circuit accommodating portion 41 (FIGS. 1 to 4). In the second case 40, by assembling the circuit accommodating member 40A and the cover member 40B, the insertion port 41a of the circuit accommodating portion 41 is covered with the cover member 40B.

In the second case 40, the circuit accommodating member 40A and the cover member 40B may be prepared as individual components, or the circuit accommodating member 40A and the cover member 40B may be molded as one component via a hinge or the like.

The second case 40 is provided adjacent to the bus bar accommodating member 30A in a direction orthogonal to the arrangement direction of the plurality of battery cells BC and the insertion direction of the bus bar 10 toward the bottom wall 32 in the bus bar accommodating portion 31 (FIGS. 1 to 3).

In the conductive module 1, the bus bar accommodating member 30A of the first case 30 and the circuit accommodating member 40A of the second case 40 may be prepared as individual components, or the bus bar accommodating member 30A and the circuit accommodating member 40A may be molded as one component via a connecting portion or the like.

Here, in the conductive module 1, the cover member 40B of the second case 40 is used to hold the bus bar 10 placed at the accommodation completion position in the bus bar accommodating member 30A of the first case 30 inside the bus bar accommodating portion 31.

First, the first case 30 includes a first engaging portion 33 provided for each bus bar accommodating portion 31 (FIGS. 1 to 4). The first engaging portion 33 for each bus bar accommodating portion 31 is also formed in the bus bar accommodating member 30A. Next, the second case 40 includes a bus bar holding portion 42 provided for each bus bar accommodating portion 31 and sandwiching the bus bar 10 at the accommodation completion position with the bottom wall 32 of the bus bar accommodating portion 31, and a second engaging portion 43 provided for each bus bar accommodating portion 31 and engaged with the first engaging portion 33 to maintain the bus bar holding portion 42 at a position for sandwiching the bus bar 10 (FIGS. 1 to 4). The bus bar holding portion 42 and the second engaging portion 43 are provided in the cover member 40B.

Specifically, the bus bar holding portion 42 is formed like a cantilever protruding from the cover member 40B toward the bus bar accommodating portion 31 (FIGS. 1 to 4). The bus bar holding portion 42 protrudes along the extending direction of the connecting portion 13 in the bus bar 10 at the accommodation completion position and along the extending direction of the bottom wall 32 of the bus bar accommodating portion 31.

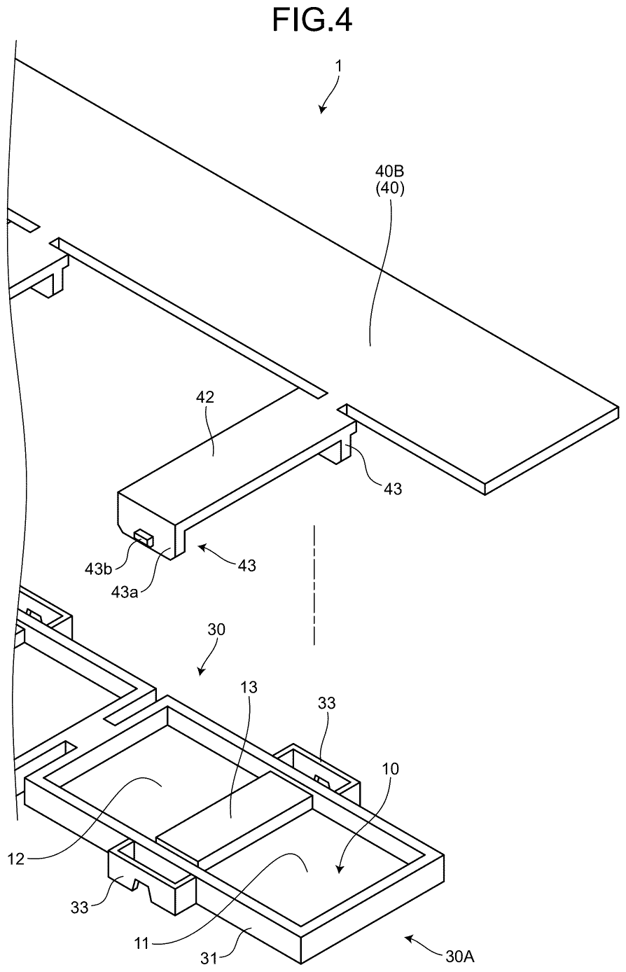

The second engaging portion 43 is provided at each of a free end and a fixed end of the bus bar holding portion 42 (FIGS. 2 to 4). The bus bar accommodating portion 31 includes a first engaging portion 33 paired with the second engaging portion 43 at the free end of the bus bar holding portion 42, and a first engaging portion 33 paired with the second engaging portion 43 at the fixed end of the bus bar holding portion 42 (FIGS. 1 to 4). For example, the second engaging portion 43 includes a piece portion 43a protruding from the bus bar holding portion 42 and a claw portion 43b protruding from a wall surface of the piece portion 43a (FIG. 4). The first engaging portion 33 is formed like a square ring, so that the second engaging portion 43 is inserted into the ring, and the claw portion 43b removed from the ring is hooked onto the first engaging portion 33, thereby holding the second engaging portion 43 in the ring.

In the conductive module 1, the circuit accommodating member 40A and the cover member 40B are assembled together in a state where the bus bar 10 is housed in the bus bar accommodating portion 31, and the first engaging portion 33 and the second engaging portion 43 are engaged with each other on the free end side and the fixed end side of the bus bar holding portion 42 in the cover member 40B. As a result, in the conductive module 1, the connecting portion 13 of the bus bar 10 is sandwiched between the bottom wall 32 of the bus bar accommodating portion 31 and the bus bar holding portion 42, and the bus bar 10 is held in the bus bar accommodating portion 31 at the accommodation completion position.

Since the conductive module 1 of the present embodiment adopts such a bus bar holding structure, the depth of the inside of the bus bar accommodating portion 31 can be made shallow to a size equivalent to the physique of the bus bar 10 in the thickness direction. Therefore, in the conductive module 1, the size of the bus bar accommodating portion 31 in the depth direction of the inside can be reduced, making it possible to reduce the size of the first case 30 in the depth direction. Therefore, the height of the conductive module 1 of the present embodiment can be reduced. For example, as mentioned above, the bus bar holding portion of the conventional conductive module has a cantilevered flexible portion extending in the depth direction of the inside of the bus bar accommodating portion, and the bus bar enters between the claw portion at the distal end and the bottom wall while bending the flexible portion. On the other hand, the bus bar holding portion 42 of the present embodiment does not affect the depth of the interior of the bus bar accommodating portion 31. Therefore, the conductive module 1 of the present embodiment can be made smaller in size than the conventional conductive module.

In addition, in the conventional bus bar holding structure, the flexible portion is bent by the bus bar while sliding the bus bar made of a metal on the flexible portion made of a synthetic resin. Therefore, in the conventional bus bar holding portion, in order to mitigate the aggressiveness of the bus bar with respect to the flexible portion, the load acting between the bus bar and the flexible portion is reduced by extending the flexible portion in the extending direction or the like. However, the extension of the flexible portion decreases the holding force of the conventional bus bar holding portion with respect to the bus bar. On the other hand, the bus bar holding structure of the present embodiment generates a force for sandwiching the bus bar 10 between the bus bar holding portion 42 and the bottom wall 32 of the bus bar accommodating portion 31 by engaging the first engaging portion 33 made of a synthetic resin and the second engaging portion 43 made of a synthetic resin with each other. That is, the bus bar holding structure of the present embodiment is capable of holding the bus bar 10 without sliding the bus bar 10 with respect to the first engaging portion 33, the second engaging portion 43, and the bus bar holding portion 42. Therefore, as compared with the conventional conductive module, the conductive module 1 of the present embodiment can improve the durability of the bus bar holding structure and the force for holding the bus bar 10.

Meanwhile, in the conductive module 1 of the present embodiment, an electrical connection component that electrically connects the bus bar 10 and the circuit conductor forming a pair may pass between the bus bar 10 and the bus bar holding portion 42. In this case, for example, the bus bar holding portion 42 is disposed with a gap for interposing the electrical connection component from the bus bar 10 placed on the bottom wall 32 of the bus bar accommodating portion 31 to sandwich the bus bar 10 via the electrical connection component. The second engaging portion 43 is provided at the free end of the bus bar holding portion 42. In this case, the second engaging portion 43 is not provided at the fixed end of the bus bar holding portion 42 to enable the electrical connection component to pass between the bus bar 10 and the bus bar holding portion 42. Therefore, the bus bar accommodating portion 31 includes a first engaging portion 33 paired with the second engaging portion 43 at the free end of the bus bar holding portion 42, and does not include a first engaging portion 33 paired with the second engaging portion 43 at the fixed end of the bus bar holding portion 42.

In the conductive module 1, for example, the electrical connection component is welded to the connecting portion 13 of the bus bar 10 to physically and electrically connect them. In the conductive module 1, the circuit accommodating member 40A and the cover member 40B are assembled together in a state where the bus bar 10 is housed in the bus bar accommodating portion 31 and the electrical connection component is welded to the connecting portion 13 of the bus bar 10. Then, in the conductive module 1, the first engaging portion 33 and the second engaging portion 43 are engaged on the free end side of the bus bar holding portion 42 in the cover member 40B. As a result, in the conductive module 1, the connecting portion 13 of the bus bar 10 and the electrical connection component are sandwiched between the bottom wall 32 of the bus bar accommodating portion 31 and the bus bar holding portion 42. Therefore, in the conductive module 1, the bus bar 10 is held in the bus bar accommodating portion 31 at the accommodation completion position, and the welded portion between the connecting portion 13 of the bus bar 10 and the electrical connection component is covered and hidden by the bus bar holding portion 42. Therefore, in the conductive module 1, in addition to the above-described effect, the exposure of the welding mark between the connecting portion 13 of the bus bar 10 and the electrical connection component can be prevented.

Since the conductive module according to the present embodiment adopts a bus bar holding structure including the bus bar holding portion, the first engaging portion, and the second engaging portion, the depth of the inside of the bus bar accommodating portion can be made shallow to a size equivalent to the physique of the bus bar in the thickness direction. Therefore, in the conductive module, the size of the bus bar accommodating portion in the depth direction of the inside can be reduced, making it possible to reduce the size of the first case in the depth direction. Therefore, the height of the conductive module according to the present invention can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a bus bar physically and electrically connected to electrode terminals of a pair of battery cells in a battery module in which a plurality of battery cells are arranged;
a circuit conductor component provided with a circuit conductor that electrically connects the bus bar to a battery monitoring unit;
a first case in which a bus bar accommodating portion that accommodates the bus bar at an accommodation completion position inside is provided for each bus bar; and
a second case provided with a circuit accommodating portion that accommodates the circuit conductor component inside, wherein
the bus bar accommodating portion is provided with a space for connecting the bus bar and the electrode terminals, and has a bottom wall on which the bus bar is placed at the accommodation completion position,
the first case has a first engaging portion provided for each bus bar accommodating portion, and
the second case has a bus bar holding portion provided for each bus bar accommodating portion to sandwich the bus bar at the accommodation completion position with the bottom wall, and a second engaging portion provided for each bus bar accommodating portion and engaged with the first engaging portion to maintain the bus bar holding portion at a position for sandwiching the bus bar.

2. The conductive module according to claim 1, wherein
the first case includes a bus bar accommodating member in which the bus bar accommodating portion for each bus bar and the first engaging portion for each bus bar accommodating portion are formed,
the second case includes a circuit accommodating member in which the circuit accommodating portion is formed, and a cover member that covers a port for inserting the circuit conductor component in the circuit accommodating portion, and
the bus bar holding portion and the second engaging portion are provided in the cover member.

3. The conductive module according to claim 2, wherein
the second case is provided adjacent to the bus bar accommodating member in a direction orthogonal to an arrangement direction of the plurality of battery cells and an insertion direction of the bus bar toward the bottom wall in the bus bar accommodating portion,
the bus bar holding portion is formed like a cantilever protruding from the cover member toward the bus bar accommodating portion,
the second engaging portion is provided at each of a free end and a fixed end of the bus bar holding portion, and
the bus bar accommodating portion includes a first engaging portion paired with the second engaging portion at the free end of the bus bar holding portion, and a first engaging portion paired with the second engaging portion at the fixed end of the bus bar holding portion.

4. The conductive module according to claim 2, further comprising:
an electrical connection component for each bus bar, the electrical connection component being physically and electrically connected to the bus bar and the circuit conductor forming a pair to electrically connect the bus bar and the circuit conductor, wherein
the second case is provided adjacent to the bus bar accommodating member in a direction orthogonal to an arrangement direction of the plurality of battery cells and an insertion direction of the bus bar toward the bottom wall in the bus bar accommodating portion,
the bus bar holding portion is formed like a cantilever protruding from the cover member toward the bus bar accommodating portion, and is disposed with a gap for interposing the electrical connection component from the bus bar placed on the bottom wall to sandwich the bus bar via the electrical connection component,
the second engaging portion is provided at a free end of the bus bar holding portion, and
the bus bar accommodating portion includes a first engaging portion paired with the second engaging portion at the free end of the bus bar holding portion.
